(19) United States
(12) Patent Application Publication
(10) Pub. No.: US 2010/0285296 A1
(43) Pub. Date: Nov. 11, 2010

(54) Apparatus and method for advanced structural foam molding

(76) Inventors: Chul B. Park, Etobicoke (CA); Xiang Xu, Mississauga (CA)

Correspondence Address: HEDMAN & COSTIGAN, P.C., 1230 AVENUE OF THE AMERICAS, 7th floor, NEW YORK, NY, 10020, US

(21) Appl. No.: 12/799,213

(22) Filed: Apr. 19, 2010

Related U.S. Application Data
(62) Division of application No. 11/219,309, filed on Sep. 2, 2005.

(30) Foreign Application Priority Data
Sep. 2, 2005 (CA) 2517995

(51) Int. Cl. B32B 3/26; B29C 47/00

(52) U.S. Cl. 428/304.4; 264/50

(57) ABSTRACT

An advanced structural foam molding technology for improving the dispersion of the blowing agent in the polymer matrix has been invented. This technological innovation is an improvement on the well-known existing low-pressure structural foam molding technology based on the preplasticating-type (so called piggy-bag) injection-molding machines. By introducing means for continuing the polymer matrix melt flow stream, preferably an additional accumulator and a gear pump, the processing conditions become more consistent to disperse the injected gas more uniformly in the polymer matrix. By using this technology, the structural foams have a smaller cell size, a more uniform cell structure, a larger void fraction (i.e., more material saving), less surface swirl, and less weld line contrast.

### FIELD OF THE INVENTION

The present invention relates to polymeric foam processing in general, and more specifically to systems and methods for manufacturing structural foams via injection molding.

### BACKGROUND OF INVENTION

Structural foams are plastic foams manufactured using conventional preplasticating-type injection-molding machines, where a physical blowing agent (PBA) and/or a chemical blowing agent (CBA) is employed to produce a cellular (foam) structure during processing. The structural foam molding technology was initially invented by Angell Jr. et al. (U.S. Pat. Nos. 3,268,636 (1966) and 3,436,446 (1969)), and further improvements were made to it (U.S. Pat. No. 3,988,403 (1976)).

Typically, low-pressure preplasticating-type structural foam molding machines are most commonly used, because the required molding system for producing large products is small with low pressure in the cavity. (J. L. Throne, Thermoplastic Foams, Sherwood Publishers, p. 210, 1996) Since the generated cells compensate for the shrinkage of injection-molded parts during cooling, structural foams typically have outstanding geometric accuracy. Because of this unique advantage, the low-pressure preplasticating-type structural foam molding technology has been widely used for manufacturing large products that require geometric accuracy.

However, there are a number of drawbacks to this technology. First, the cell number density (or cell density) of structural foams is typically less than 10³ cells/cm₃, the cell size is greater than 1 mm, and the cell-size distribution is very non-uniform. Structural foams also have very poor surface quality, very low void fraction, and poor mechanical properties (due to the large gas pockets). The processing conditions and the product quality are very inconsistent, too. Development work has been broadly practiced to improve the cellular structure, surface quality, and process consistency in the structural foam molded products.

Efforts have been made to improve the structure of injection-molded foams based on a preplasticating-type system using different designs of the accumulator, gate assembly and nozzle assembly. In U.S. Pat. No. 5,124,095 issued in 1992 to R. F. Gianni et al., a method was developed to prevent plastic degredation in the accumulator by allowing for the melt which enters the accumulator first, to be the first to leave the accumulator. They also developed a special gate assembly. In U.S. Pat. No. 5,098,267 issued in 1992 to A. T. Cheng, by designing a special cylindrical plunger, improvements were made to process the mold structural foam articles using a resin plasticating barrel. A specially designed mixing nozzle assembly was developed in U.S. Pat. No. 4,548,776 issued in 1985 to J. Holdredge. In this invention, a valve-like mixing nozzle assembly including a rotating mixing turbine, mounted in the flow path of the plastic material can be selectively operated to control the flow of plastic material into an injection mold and thereby to improve the cellular structure of molded foams.

High-pressure structural foam molding has been developed and widely practiced to improve the surface quality of structural foams by using an expandable mold. In a typical high-pressure process, a foamable polymer melt is injected into the mold cavity with a full shot; the melt is then subjected to high packing pressure to compress the cells formed during mold filling; after a solid skin is formed, the overall mold volume is expanded; then with the compression released, foaming of the core materials fills out the mold. A good example is U.S. Pat. No. 3,801,686 issued in 1974 to W. T. T Kyritsis et al. Another variation of this process is that instead of moving the mold, one or more movable cores that initially occupy part of the mold cavity can be used to provide a necessary foaming space. This variation is known to be good for thick-walled parts. An example of this variation is British Patent 1,194,191. The high-pressure process can produce the finishes superior to those of the low-pressure one, but compared to the high cost, it can only provide a partial improvement in surface appearance by compression of the foams formed in the solid skin On the other hand, parts geometry is limited due to the requirements of moving mold, and the molding system should be larger because of the high pressure in the mold.

Gas counter-pressure foam molding was developed purely as the swirl-free molding technique, and has received a considerable amount of attention. The concept behind counter-pressure is to utilize a gas pressurized mold, which, through controlled venting allows the foam expansion stages of the cycle to occur after a smooth surface has been formed. Numerous development efforts starting as early as the mid-seventies have advanced the gas counter-pressure molding technology. Examples include U.S. Pat. No. 4,255,368 issued in 1981 to O. Olabisi, and U.S. Pat. No. 4,952,365 issued in 1990 to T. Shibuya et al.

A technology that combines high-pressure structural molding and gas counter-pressure in order to accommodate the benefits from both processes was also developed. It was claimed that such a process could generate a foamed thermoplastic article having smooth and glossy surfaces free from swirl marks and hair cracks. In this process, a thermoplastic melt containing a blowing agent is first injected into a gas-pressurized mold cavity in a full shot, then releasing the gas pressure, and thereafter enlarging the volume in the molded cavity by movement of a mold wall. Examples include, U.S. Pat. No. 4,096,218 issued in 1978 to A. Yasuike et al., U.S. Pat. No. 4,133,858 issued in 1979 to A. Hayakawa et al., and U.S. Pat. No. 4,783,292 issued in 1988 to R. K. Rogers.

Efforts on material modifications have also been made to improve the quality of molded foams. In U.S. Pat. No. 3,950,484 issued in 1976 to E. A. Egli, an improvement was made by using a foaming agent and finely divided lithopone particles comprising of about 30% zinc sulfide and about 70% barium sulfate. In U.S. Pat. No. 4,255,367 issued in 1981 to C. W. Wallace et al., various additives were selectively introduced, for either the skin or core portion of the articles, into the polymer melt downstream of an accumulation device and upstream of a static mixer just prior to its introduction into the mold cavity.

Efforts have also been made to properly control the polymer and gas flow. In U.S. Pat. Nos. 6,322,347 issued in 2001 and 6,579,910 issued in 2003 to J. Xu, a restriction element was invented to reduce the backflow of polymer melt in the extrusion barrel during injection and ejection period to produce microcellular foam based on a reciprocating-type injection molding system. In U.S. Pat. No. 6,451,230 issued in 2002 to H. Eckardt, a method to maintain a constant pressure difference between the pressure of the injected gas and the pressure in the thermoplastic melt was introduced to improve the cell structure.

In order to remove the typical defects of injection foam molded parts such as mottled areas, visible flow lines, and pin holes, efforts have also been made to amend the molding process or use a different processing method. In U.S. Pat. No. 4,031,176 issued in 1977 to R. A. Molbert, a process was developed where a short-shot of the expandable thermoplastic was injected into an elastic membrane positioned within a cooled mold cavity. In U.S. Pat. Nos. 4,067,673 issued in 1978, 4,155,969 issued in 1979, and 4,390,332 issued in 1983 to J. W. Hendry, a process to provide a predetermined skin thickness of an injection foam molded part was developed by first injecting solid plastic resin into a mold and then injecting a foamed plastic resin like in co-injection molding but with one extrusion barrel.

Efforts have also been made to introduce subsequent shaping to structural foam molding. In U.S. Pat. No. 4,022,557 issued in 1977 to K. G. Johnson, structural foam profiles can be made by drawing a partially expanded thermoplastic material containing a foaming agent by a puller mechanism through a chilled shaping or sizing die and allowing its continuous expansion in the interior of the profile to develop foam in the core while the surface layer is cooled. In U.S. Pat. Nos. 5,202,069 issued in 1993 and 5,348,458 issued in 1994 to T. M. Pontiff, structural foams were produced by first extruding a foamable melt through a die orifice, then compressing the foamed thermoplastic material by a vertically-oriented mold into the desired shape.

Whereas a preplasticating-type injection-molding machine has been used in structural foam molding for manufacturing large products with thick sections, a reciprocating-type injection-molding machine has been used to produce microcellular foams for the products with thin sections. A great deal of effort has been made to develop and improve the “Mucell” technology for producing microcellular foams that have much finer cell size and higher cell density, based on the reciprocating-type system without an accumulator. In U.S. Pat. No. 5,866,053 issued in 1999 to C. B. Park et al., microcellular foams can be produced by inducing a thermodynamic instability through a rapid pressure drop, e.g., higher than 0.9 GPais in the nucleation device of an extrusion system. In U.S. Pat. No. 6,294,115 issued in 2001. to K. Blizard et al., a microcellular injection-molded article having an average cell size of less than about 60 microns can be produced using a polymeric material, a nucleating agent in an amount between about 2.5 and about 7 weight percent, and a blowing agent amount less than 1.5 weight percent by inducing a pressure drop rate less than 1.0 GPa/s in the solution of blowing agent and polymeric material. In U.S. Pat. No. 5,334,356 issued in 1994 and RE37,932 in 2002 to D. F. Baldwin et al., microcellular and supermicrocellular foamed materials having cell densities in the range of about 10⁹ to 10¹⁵ cells per cubic centimeter of the material with the average cell size being at least less than 2.0 microns can be produced by inducing a thermodynamic instability to the plastic material saturated with a sufficient amount of supercritical fluids. In U.S. Pat. No. 6,593,384 issued in 2003 to J. R. Anderson et al., microcellular polymeric materials can be produced using a very low blowing agent level (less than 0.08% by weight) via injection molding based on the reciprocating-type injection molding system. In U.S. Pat. No. 6,884,823 issued in 2005 to D. E. Pierick et al., microcellular foams can be produced by controlling pressure drop rate and shear rate via a nucleator that is upstream to the pressurized mold and extrusion system with a reciprocating screw.

Microcellular foams have also been produced using expandable hollow microspheres. In U.S. Pat. No. 5,665,785 issued in 1995 to T. R. McClellan, it was claimed that microcellular foams can be produced by adding expandable thermoplastic hollow microspheres containing a volatile material in an injection molding process. In U.S. Pat. No. 6,638,984 issued in 2003 to D. S. Soane et al., it was claimed that microcellular foams can be made upon heating the thermo-expandable microspheres which are characterized by having a polymeric wall surrounding one or more pockets or particles of blowing agent or propellant within the microsphere.

Microcellular molded foams have also been made by other methods. In a technical paper presented by M. Shimbo et al. (Foams'99, pp. 132-137, 1999), microcellular injection molding was demonstrated based on a preplasticating-type system on a small scale. In their work, efforts were made to independently control the plastication and injection process. However, this art does not teach how to stabilize the barrel pressure in order to better disperse the gas in the polymer melt. On the other hand, W. Michacli and S. Habibi-Naini developed the Optifoam Technology that can produce microcellular molded foams via a specially designed nozzle assembly with a gas loading capability, and an intensified mixing function based on an in-line reciprocating injection molding system (Blowing Agent and Foaming Process 2003 conference, RAPRA, Munich Germany, 2003).

Although the above-mentioned technologies such as an expandable mold, a mixing nozzle, a mold membrane, etc. have been made to produce uniformly distributed fine-celled structures and to improve surface quality in the structural foams produced from various injection molding machines including the preplasticating-type systems, they are known to be expensive. With the same intention of improving cellular structure and surface quality of structural foams, the present invention is directed to improving the process consistency while simplifying the required system modification based on the widely-practiced preplasticating-type structural foam molding system. It is our purpose to propose an inexpensive method to effectively improve the uniformity of cellular structure, the surface quality, and the consistency of production process based on a preplasticating-type structural foam molding system.

### SUMMARY OF INVENTION

We have found that much more improved structural foam articles with a finer cell size, more uniform distribution, high surface quality, and a larger void fraction can be manufactured using the present invention. This invention is a processing technology based on the modification of the conventional low-pressure preplasticating-type structural foam molding system. This invention can be applied easily by retrofitting the existing low-pressure structural foam molding machines with slight modification.

Our advanced low-pressure structural foam molding technology is characterized by a design that facilitates the uniform dispersion/dissolution of gas in the polymer melt during the structural foam molding process, thereby minimizing the chance of creating large undissolved gas pockets. Knowing that the stop-aid-flow molding behaviors inevitably cause inconsistent gas dosing, we propose to use an additional accumulator (i.e., a hydraulic piston, a spring-loaded piston, an expandable tube, or some instrument of this nature) combined with a gear pump, between the extrusion barrel and the shut-off valve (before the main accumulator) to completely decouple the gas dissolution operation from the injection and molding operations. This invention would ensure that the pressure in the extrusion barrel can be relatively well maintained and that consistent gas dosing can be attained to achieve a uniform polymer/gas mixture regardless of the pressure fluctuations caused by the injection and molding operations.

From this invention, almost the same level of cell (number) density in the range of 10⁴.about.10⁷ cells/cm³ can be achieved as in conventional extrusion foaming based on the heterogeneous nucleation scheme. Since this cell density is much higher than that of the conventional structural foams, i.e., 10¹.about.10³ cells/cm³, the cell size of structural foams becomes much smaller by using the present invention. Therefore; the surface quality, the void fraction, and the mechanical properties of the produced structural foams are increased accordingly.

The cost of manufacturing the parts in structural foam molding is significantly reduced by using our invention. Because the void fraction is increased by 10.about.20%, the expensive plastic material will be used less, and therefore, the material cost will be reduced accordingly. Since the plastic material cost of structural foam molding is typically about 50% of the total cost, the total cost will be reduced by 5.about.10% from the reduced amount of plastic material. In addition, the cost for CBA will also be significantly reduced. It should be noted that this cost reduction is accompanied with the enhanced properties of structural foams.

Another major benefit of the present invention is the consistency of the product quality and the manufacturing (processing) conditions due to the consistent gas dosing realized by the art provided in this invention.

### BRIEF DESCRIPTION OF THE DRAWINGS

FIG. 1 shows a schematic illustration of system configuration Option 1.

FIG. 2 shows a schematic illustration of system configuration Option 2.

FIG. 3 shows a schematic illustration of system configuration Option 3.

FIG. 4 shows a schematic illustration of system configuration Option 4.

FIG. 5 shows a schematic illustration of system configuration Option 5.

FIG. 6 shows a schematic illustration of system configuration Option 6.

FIG. 7 shows a schematic illustration of system configuration Option 7.

FIG. 8 shows a schematic illustration of system configuration Option 8.

FIG. 9 shows a schematic illustration of system configuration Option 9.

FIG. 10 shows a schematic illustration of system configuration Option 10.

FIG. 11 shows a schematic illustration of system configuration Option 11.

FIG. 12 shows a schematic illustration of system configuration Option 12.

FIG. 13 shows the cell density of HDPE structural foams produced from this invention at various talc sizes, talc contents, and N₂ contents.

### DETAILED DESCRIPTION OF THE INVENTION

In today's most commonly used low-pressure structural foam molding technology with a low-pressure preplasticating-type (so-called piggy-bag) system, the injected gas (typically N₂) amount is normally beyond the solubility limit locally or globally. It is because of the overdosed gas content and/or the pressure fluctuations during each cycle, that the injected gas cannot completely dissolve into the polymer matrix during processing.

Furthermore, the amount of the gas injected into the polymer melt is not consistent because of the uou-steady nature of the existing low-pressure structural foam molding process. In existing low-pressure structural foam molding systems, a shut-off valve is typically used between the plasticating extrusion barrel and the accumulator to prevent the reverse flow from the accumulator to the extrusion barrel. However, this shut-off valve cannot completely decouple the functions of the extrusion barrel and the accumulator. Since the valve needs to be shut off during the injection period, the rotation of the plasticating screw needs to be stopped; otherwise, the material supplied from the extrusion barrel will go nowhere and the system pressure may exceed the safety limit which is both dangerous and potentially damaging. Once the injection and molding operations have been completed, the valve is opened, the accumulation resumes, and the rotation of the screw is restarted. This stop-and-flow process in the extrusion barrel causes significant pressure fluctuations in the barrel. Because the amount of injected gas is greatly affected by the barrel pressure, the fluctuations of the barrel pressure will lead to an inconsistent gas dosing into the polymer melt stream. As a result, a non-uniform state of polymer/gas mixture is attained, which is very detrimental to the achievement of a uniform and fine-celled foam structure. Although U.S. Pat. No. 6,451,230 teaches how to better control the gas flow rate for the reciprocating-type machines to improve the consistency of the gas flow rate, that art does not teach how to stabilize the barrel pressure and thereby achieve better dispersion of gas in the polymer melt, especially for the low pressure preplasticating-type structural foam molding machinies.

The above-mentioned technological limitations of most structural foam molding machines often result in the manufacture of final foam products with undesirable properties. First of all, the manufactured structural foams typically have uncotrallably formed numerous large gas pockets, especially along the weld lines, which governs the maximum achievable void fraction of the final foam products. The void fraction of structural foam determines the materials saving, and therefore, it is desirable to maximize the achievable void fraction. In the currently practiced structural foaming technology in a low-pressure preplasticating-type system, the achievable void fraction is in the range of 0.08 to 0.20 and is typically determined by the geometry of the products (i.e., a low void fraction for complicated geometry and a high value for simple geometry) and the shot size. If a higher void fraction is intended to be achieved by decreasing the shot size for a given geometry, the rate of scrapping and recycling the defective products is increased because of the uncontrollably formed large gas pockets in the final products. Secondly, the inconsistent, non-uniform and excessive gas dosing ultimately leads to the deterioration of foam properties (i.e., the mechanical properties, in particular) through the formation of large gas pockets. Despite the low void fraction, the structural foams have degraded the mechanical properties because of the large gas pockets generated in the foam. Thirdly, the non-uniform and/or excessive addition of gas also causes serious surface defects such as non-uniform surface swirl, color contrast across the weld lines, and weld line traces on the part's surface, which are another outstanding drawback of existing structural foam molding technology.

However, our new technology guarantees uniform gas dispersion and complete (or substantial) dissolution in the polymer melt, despite the non-steady molding nature. Recognizing that the stop-and-flow molding behaviors inevitably cause inconsistent gas dosing, we hereby propose with this patent that means for allowing the flow of the polymer melt to continue (i.e., not be stopped during the injection period), which means preferably comprise a positive displacement pump, such as a gear pump, combined with an additional accumulator (i.e., a hydraulic accumulator, a spring-loaded piston, an expandable tube, or some instrument of this nature), be attached between the extrusion barrel and the shut-off valve (before the main accumulator). The approach is to completely decouple the gas dissolution step from the injection and molding operations using means such as the positive-displacement gear pump, and to maintain the gas dissolution step in a steady state with respect to time. During the injection and molding operations, the plasticating screw is still rotating and the generated polymer/gas mixture is accumulated in the newly added accumulator. After the injection and molding operations, the temporarily stored polymer/gas mixture in the new accumulator is moved to the main accumulator to be injected in the next cycle. Our invention would ensure that the pressure in the extrusion barrel can be relatively well maintained to be constant, and that consistent gas dosing can be attained to achieve a uniform polymer/gas mixture regardless of the pressure fluctuations in the main accumulator caused by the injection and molding operations.

In order to maintain consistent gas dosing into the polymer and to completely (or substantially) dissolve all the gas in the polymer melt, a relatively constant rotational speed of the screw is maintained in the present invention. The advantages of having a constant rotational speed of the screw are twofold. Firstly, the pressure fluctuations inside the extrusion barrel can be minimized so that a consistent gas dosing can be easily realized. Secondly, the dissolution of the injected blowing gas into the polymer melt can be guaranteed by maintaining a high pressure. A uniform polymer/gas mixture with a constant gas-to-polymer weight ratio in which the gas has been completely (or substantially) dissolved provides the basis for producing a uniform and fine-celled foam structure unlike the existing structural foam molding technologies.

Use of a gear pump is preferred because it entails a very important benefit of controlling the pressure in the extrusion barrel and thereby maintaining a consistent polymer-to-gas weight ratio. Firstly, the pressure in the extrusion barrel will be relatively well maintained due to the positive displacement nature of the gear pump for the viscous polymer melts. Since the gas flow rate is a sensitive function of the barrel pressure, a constant gas flow rate can be obtained by having a constant pressure in the extrusion barrel as mentioned above. Secondly, the flow rate of polymer/gas mixture can be controlled by varying the rotational speed of the gear pump. Therefore, by independently controlling both the flow rates of gas and polymer/gas mixture, the polymer flow rate can also be controlled, and thereby a consistent polymer-to-gas weight ratio can be easily achieved. As a result, the uniform state of polymer/gas mixtures can be easily accomplished. The application of a gear pump confers this very unique advantage, which may not be achieved with a shut-off or non-returnable check valve.

However, when the wear on the gear pump is severe, there will be internal leakage through the gears inside the gear pump and any pressure fluctuations in the accumulator may affect the extrusion barrel pressure to a certain degree. In this case, a slight increase in the rotational speed of the gear pump during injection can compensate for the leakage (to maintain the same pressure in the inlet of the gear pump). But the effect of the pressure fluctuations due to the wear of the gear pump during the short injection time may not be significant in most cases.

An additional accumulator should be attached to accommodate the material during the injection period in each cycle so that the screw can continuously rotate and gas can be continuously injected into the melt. This model represents a significant difference from all the previous structural foam molding technologies based on the low-pressure preplasticating-type system because of the constantly rotating screw speed. Once the pressure in the extrusion barrel can be maintained at a relatively stable value, the flow rate control of the injected gas into the polymer becomes relatively easier to perform and the gas can be more uniformly dispersed into the melt.

Preferably, this accumulator can be hydraulically driven, so that a constant melt pressure can be maintained. But a piston loaded with a spring can also be used as an accumulator. In the case of using a spring-loaded piston, the pressure will increase over time as the melt/gas mixture is accumulated in the accumulator because the force of spring (and thereby the melt pressure) is proportional to the displacement of the piston. An expandable tube can also function the same as a spring-loaded piston. Although the pressure of the accumulated melt increases, the gear pump will prevent the pressure increase in the barrel corresponding to this pressure increase in the accumulator. Again, if a pressure increase in the extrusion barrel is observed due to the wear in the gear pump, a slight increase in the rotational speed of the gear pump can maintain the same barrel pressure (and thereby the same flow rate of the polymer/gas mixtures) as described earlier.

If a gear pump is not used and only an accumulator is additionally added, the control of maintaining a consistent pressure in the extrusion barrel would not be as easy as in the case of using a gear pump. In this case, a certain degree of fluctuations in the gas-to-polymer weight ratio would be obtained. However, by modifying and operating the system properly, these fluctuations can be decreased substantially. First, at least a shut-off valve (or a. non-returnable check valve) needs to be used to isolate the gas-dissolution process from the injection and molding operations as in the case of the existing structural foam molding system. Furthermore, in order to continuously form a polymer/gas mixture, an additional accumulator needs to be installed before the shut-off valve (or non-returnable check valve). This accumulator stores the formed polymer/gas mixture during the injection operation. If a hydraulically driven constant-pressure cylinder is used, the gas amount can be relatively easily adjusted accordingly because of the constant accumulator pressure (and thereby the constant barrel pressure). So in the case of using no gear pump, use of a hydraulically driven accumulator is strongly recommended. If a spring-loaded piston or an expandable tube is used as the accumulator instead of a hydraulic one, the accumulator pressure will be increased over time (as described above). Since there is no gear pump between the extrusion barrel and the additional accumulator, the barrel pressure will also be increased over time. For a small shot-sized product (i.e., with a short injection time), this may not affect the consistency in the final product significantly. But for a large shot-sized product, it may be difficult to maintain a consistent gas-to-polymer weight ratio in the polymer melt. As a result, the final product may have non-uniform cell structures. But because of the additionally attached accumulator and the continuous rotation of the screw, the dispersion of gas in the polymer melt is still better than that in the currently practiced structural foam molding technology, and consequently, the cell structure is better than that of the current structural foams.

When a consistent gas-to-polymer weight ratio is achieved, complete dissolution of the injected gas may be performed by maintaining a “sufficiently high pressure” in both the extrusion barrel and the accumulators. A “sufficiently high pressure” indicates that the melt pressure is much higher than the solubility pressure for the given amount of gas injected into the polymer melt. When such a high pressure is applied to the mixture, dissolution of the injected gas in the polymer melt is facilitated. In addition, maintaining a “sufficiently high pressure” after complete dissolution of gas indicates that the formation of a second phase in the polymer melt is prevented during the accumulation stage. Since the solubility pressure for the appropriate gas content that can produce a fine-celled structure is relatively low (e.g., 140 psi.about.1,400 psi for 0.1% .about.1.0% N₂ in HDPE) compared to the pressure capacity of any existing low-pressure preplasticating-type structural foam molding machines (.about.3,000 psi), a “sufficiently high pressure” can be easily maintained in the retrofitted low-pressure structural foam molding machines.

Although complete dissolution of the injected gas is preferred by maintaining a “sufficiently high pressure” in both the extrusion barrel and the accumulators, a low pressure can also be chosen during the practice of our invention in the extrusion barrel and/or the accumulators to mechanically disperse the injected gas in the polymer melt as described in U.S. Pat. No. 4,548,776. For example, the pressure in the accumulator can be chosen to be lower than the solubility pressure during some period of time. In another case, the extrusion barrel pressure may be below the solubility pressure so that the injected gas bubbles can be mechanically dispersed by the mixing actions of the mixing elements on the screw (and optionally the static mixers) instead of completely dissolving the gas into the polymer matrix. Even if the pressure is higher than the solubility pressure, the injected gas (especially N₂ with a low solubility) may not be dissolved completely in the polymer melt because of the low solubility of gas and/or the short residence time. Then the dispersed second-phased gas pockets will be most likely the nuclei of the cellular structure in the molded foams regardless of the added nucleating agent. Because of the consistency in the gas content in the polymer using the additional accumulator and the gear pump, the cellular structure will be uniform. If a constant, high speed of the screw can be maintained with a special screw design, the dispersed second phase gas pockets will be fine, and therefore the resultant cell structure will be fine. But if the rotational speed of the screw is not really high, the mixing of polymer and gas may not be typically done well because of the high viscosity ratio of the polymer melt and the gas. As a result the cell density of the foam would be most likely lower than that in the case of completely dissolving the gas. So a sufficiently high pressure is preferred to completely dissolve the injected gas in the polymer melt.

Once the injected gas dissolves in the polymer melt uniformly, the cell-nuclei density will be governed by the distributed nucleating agent. In this case, any commonly used nucleating agents (such as talc, CaCO₃, or a small amount of second phase polymer in blend) can be added and distributed in the polymer matrix to produce a fine-cell structure. By utilizing this heterogeneous nucleation scheme based on these nucleating agents, a reasonably high cell density of 10⁴ about.10⁷ cells/cm³, can be easily achieved from any conventional extrusion foam processing (C. P. Park, Chap 8, Polyolefin Foam, in: Polymeric Foams and Foam Technology, 2nd Ed., D. Klempner and V. Sendijarevic, Ed., Hanser Publishers, Munich, 2004; S. T. Lee, Poly. Eng. Sci., 33, 418-422, 1993; S. T. Lee, J. Cellular Plast., 30, 444-453, 1994; U.S. Pat. No. 5,250,577, and U.S. Pat. No. 5,389,694). It should be noted that inducement of this fine-cell density in extrusion does not need such a high pressure drop rate required for microcellular nucleation (as described in U.S. Pat. No. 5,866,053). This cell-density can be easily obtained in extrusion foaming as long as the nucleating agent is used and the blowing agent is uniformly dispersed. It should also be emphasized that this cell density is easily obtained in extrusion because a uniform concentration of gas in the polymer can be relatively easily obtained in extrusion though the constantly maintained barrel pressure. From this, we could theoretically conclude that a similar cell density of 10⁴.about.10⁷ cells/cm³ should be obtained from the structural foam molding as long as the gas dissolves in the polymer matrix uniformly. Interestingly talc or CaCO₃ has already been used in the existing structural foam molding technology and that heterogeneous nucleation will occur once there is gas uniformly dissolved in the polymer. However, because of the difficulties that arise with complete and uniform dissolution of gas in the polymer melt in the conventional low-pressure structural foam molding process, the added nucleating agents cannot play the same role that they play in extrusion foaming. Instead, the undissolved pockets typically govern cell nucleation and a very low cell density in the range of 10¹about.10³ cells/cm³ (typically with a large cell size above 1 mm) is obtained even though talc is added however, with this new technology, i.e., by dissolving the blowing agent uniformly through the attached gear pump and additional accumulator, we can produce foams with cell densities that match those of extruded foams. This means that the cell nucleation mechanism in the new technology is almost the same as that observed in conventional extrusion foaming.

We also noted that once the gaseous blowing agent is well dissolved into polymer, a small amount of chemical blowing agent (CBA) can also be used to help regulate cell nucleation and generate a high cell nucleation rate across the polymer matrix. Thus very uniform and fine-celled foams with a cell density in the range of 10⁴ about 10⁷ cells/cm³ can be achieved. This is a commonly well known and well practiced art in the extrusion foam processing (C. P. Park, Chap 8, Polyolefin Foam, in: Polymeric Foams and Foam Technology, 2nd Ed., D. Klempner and V. Sendijarevic, Ed., Hanser Publishers, Munich, 2004; E. H. Tejeda et al, J Cellular Plastics, 41, 417-435, 2005). It is interesting to know that most existing low-pressure structural foam molding processes have also been using a CBA together with the injected physical blowing agent (i.e., N₂). But because of the poorly dispersed N₂ in the melt, the CBA has not played well as a nucleating agent. In fact, the amount of expensive CBA used in the existing structural foam molding technology is typically high (up to 0.5% .about.1.0%), and consequently the CBA has played as a blowing agent. But in our new technology, the required amount of CBA as a nucleating agent would be much smaller (typically an order of magnitude smaller than the currently used CBA amount in the existing structural foam molding process), and therefore the cost of CBA can be significantly reduced. It should be noted that a large quantity of CBA can be still used together with the injected N₂ in our technology, but it would be unnecessary.

In addition to the gaseous blowing agents (such as N₂, CO₂, Ar, He, etc.), any high molecular-weight blowing agents, such as HCs, HFCs, HCFCs, and FCs, can also be used with a proper amount of nucleating agent.

The present invention may also be used to produce fine-celled wood fiber/plastic composite structural foams. In this case, both wood fiber and void can be used to decrease the expensive plastic cost. Unlike in extrusion, the volatile generated from the wood fibers are liquified under pressure in the mold and only the added blowing agent contributes to the void fraction. The volatiles/extractions generated from the wood fibers will play as a nucleating agent together with any added nucleating agent. But too high a content of volatiles/extractives will make the wood fiber/plastic product weaker, and therefore a low processing temperature is recommended. In this perspective, the present invention is better than the currently practiced CBA based foam injection molding of wood fiber composites (A. K. Bledzki and O. Faruk, Blowing Agents and Foam Processing, Stuttgart Germany, May 10-11, 2005). In order to decompose the CBA, the polymer/WF composite should be heated to a high temperature and a significant amount of volatiles will be generated as described in U.S. Pat. No. 6,936,200. But the present invention of making the injected N.sub.2 be better dispersed and play a proper role as the blowing agent can avoid the need to overheat the materials and therefore the generated volatiles will be much less, indicating better wood fiber composite foams.

One of the striking features of this new technology is the easy retrofittability to any preplasticating-type structural foam molding machines, especially, to the low-pressure molding machines, without major modification. Because the cell nucleation rate is less sensitive to the pressure-drop rate with the heterogeneous nucleation scheme a high injection pressure would not be required to achieve the desirable cell density of 10⁴ about.10⁷ cells/cm³. This means that the pressure capacity of any existing low-pressure structural foam-molding machines (typically 3000 psi) would be more than sufficient for practicing this new technology. This pressure capacity is also higher than the “sufficiently high pressure” to dissolve the injected gas as discussed above. Therefore, retrofitting the existing low-pressure structural foam molding machines to our technology can be easily done by simply adding an additional accumulator and a gear pump. The high-pressure structural molding machines can also be retrofitted without any difficulty. But the reciprocating-type injection molding machines cannot be easily retrofitted to this technology. For the reciprocating systems, ( ) other technologies can be used. It should be emphasized that this invention is only for the preplasticating-type injection molding machines.

Several system configuration options can be generated based on the above-mentioned concepts.

### Option 1:

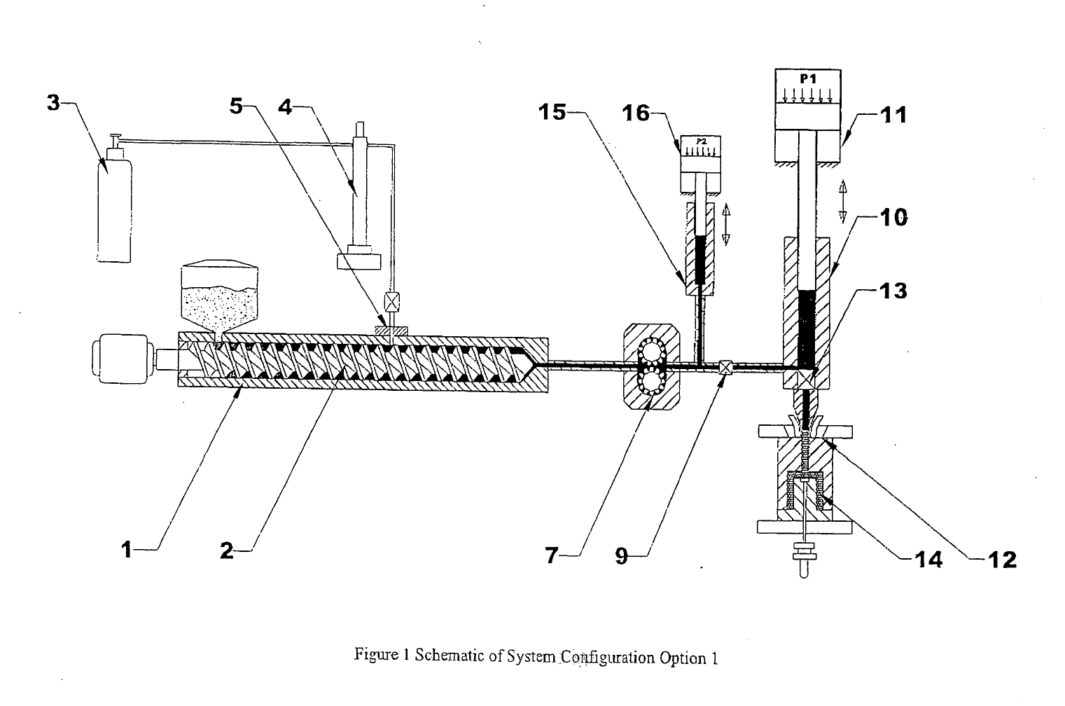

As illustrated in FIG. 1 the extrusion barrel (1) melts and moves the polymer forward through the rotation of its plasticating screw (2). The gaseous blowing agent originally contained in a gas cylinder (3) is pressurized first and then metered by a gas pump (4) while being consistently injected into the extrusion barrel (1) through a gas injection port (5), which is mounted on the extrusion barrel (1). After entering the extrusion barrel (1), the gas initially mixes with the polymer melt and forms a second phase; it gradually dissolves into the polymer melt through the rotating motion of the screw (2). The screws (2) may have optionally some mixing sections to enhance the mixing and dissolution of gas in the polymer melt. The art of using mixing section of the screw is well known. By using a gear pump (7), as discussed earlier, the pressure in the extrusion barrel (1) can be relatively well maintained because of the positive displacement nature of the gear pump (7).

Through a shut-off valve (or a non-returnable check valve) (9), the mixture is then charged into the main accumulator (10) to accumulate a desirable shot size. During this accumulation stage, a sufficiently high back pressure can be applied to the mixture using a hydraulic system (11).

When the ideal shot size is obtained in the accumulator (10), the mixture is ready to be injected into the mold (12). At that moment, the shut-off valve (9) is closed; a hydraulic pressure is applied on the piston of the hydraulic system (11) for injection. Next, the nozzle shut-off valve (13) mounted between the accumulator (10) and the mold (12) is opened, the foamable mixture is forced into the mold cavity through the runner and the gate, and foaming occurs simultaneously.

During the mold-filling period, the main shut-off valve (9) is closed. But the plasticating screw (2) in the extrusion barrel (1) is continuously rotating at the same speed and the gas is also continuously injected into the melt. The gear pump (7) is running at the same speed. This continuously formed polymer/gas mixture is now accumulated in the secondary accumulator (15) driven by hydraulic system (16) during injection (or mold filling). After mold filling, the nozzle shut-off valve (13) is closed and the main shut-off valve (9) is opened. This makes the main accumulator (10) start to receive the polymer/gas mixture from the gear pump (7). At the same time, the secondary accumulator (15) starts to discharge the stored polymer/gas mixture to the main accumulator (10) as well. This can be done by setting up a slightly higher pressure in the secondary accumulator (15). The higher pressure in the secondary accumulator (15) will not affect the barrel pressure much because of the gear pump (7).

Once the molded part (14) is cooled, it is rejected out to empty the mold and to be ready for the next cycle.

For retrofitting of the existing structural foam molding machines to Option 1 configuration, only a gear pump (7) and a hydraulic based (16) secondary accumulator (15) need be attached to the existing system.

### Option 2:

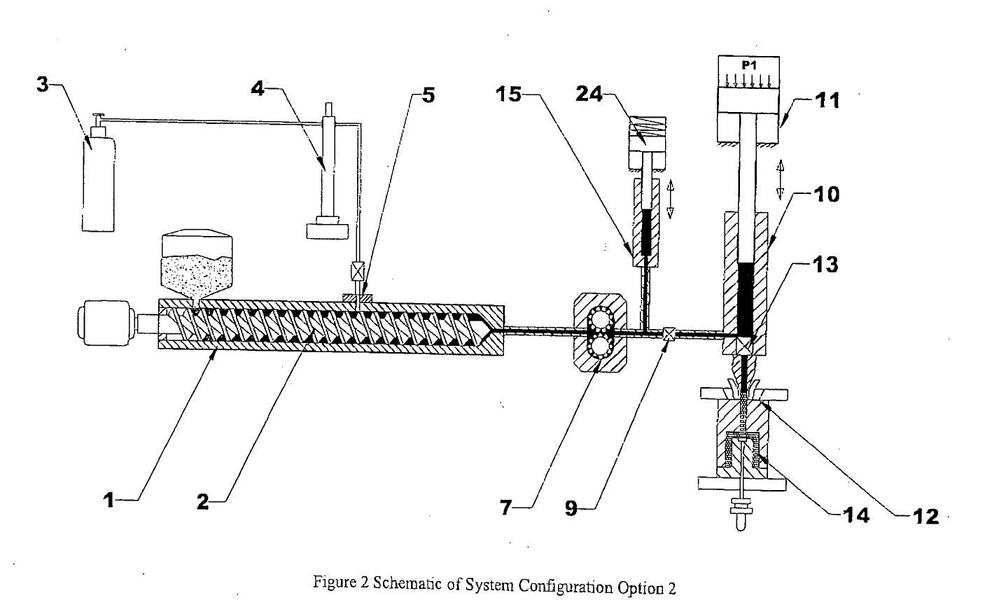

FIG. 2 shows another configuration. This system is exactly the same as that of Option 1 (shown in FIG. 1) except for the restraining mechanism of the secondary accumulator (15). Instead of using a hydraulic system that is operated under a constant pressure, a spring-loaded piston (or an expandable tube) (24) is used as the secondary accumulator. The exact same operation is used as in the case of Option 1 and the only difference is the pressure in the secondary accumulator (15). But the pressure changes in the secondary accumulator (15) could not affect the barrel pressure significantly because of the gear pump (7).

For retrofitting to the Option 2 configuration, only a gear pump (7) and a spring-loaded piston (or an expandable tube) (24) need to be attached to the existing structural foam molding system.

### Option 3:

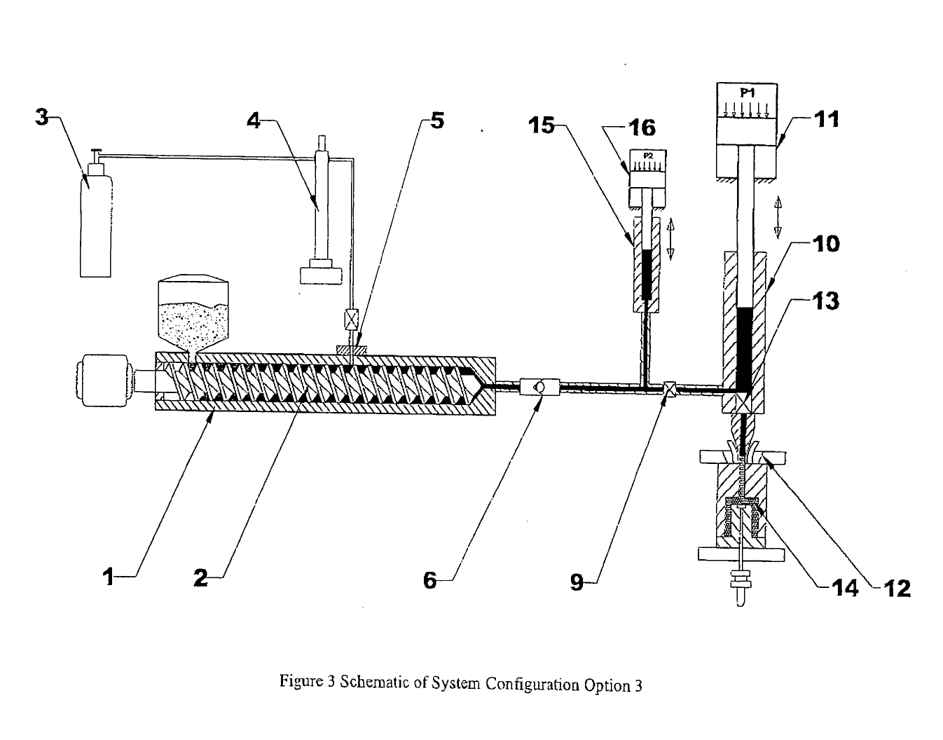

FIG. 3 shows a variation of Option 1 (shown in FIG. 1). The only difference from Option 1 is that there is no gear pump used between the extrusion barrel (1) and the secondary accumulator (15). Instead, a non-returnable check valve (6) can be optionally used. The constant pressure-driven hydraulic piston (16) will make the pressure in the barrel (1) relatively constant during injection. But there would be slight pressure fluctuations due to the pressure difference in the accumulators.

For retrofitting to the Option 3 configuration, only a hydraulically driven secondary accumulator (16) and optionally a non-returnable check valve (6) need to be attached.

### Option 4:

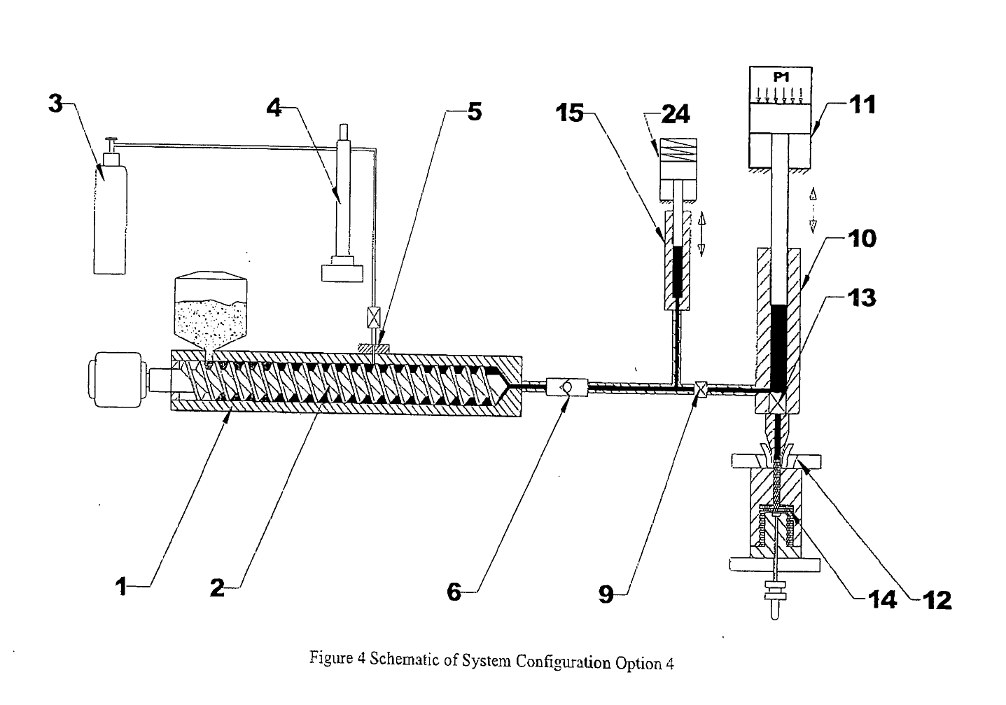

FIG. 4 shows a variation of Option 2 (shown in FIG. 2). The only difference from Option 2 is that there is no gear pump used between the extrusion barrel (1) and the secondary accumulator (15). Instead, a non-returnable check valve (16) can be optionally used. Since a spring-loaded piston (or an expandable tube) (24) is used for the secondary accumulator (15), the accumulator pressure will increase as the accumulated amount increases. If the shot size is small and therefore the injection time is short, the changes of the gas content in the polymer melt due to the increase in the pressure of secondary accumulator (15) (and thereby due to the increase in the barrel pressure) may not be large.

For retrofitting, only a spring-loaded piston (or an expandable tube) (24) and optionally a non-returnable check valve (6) need to be attached to the existing structural foam molding machines.

### Option 5:

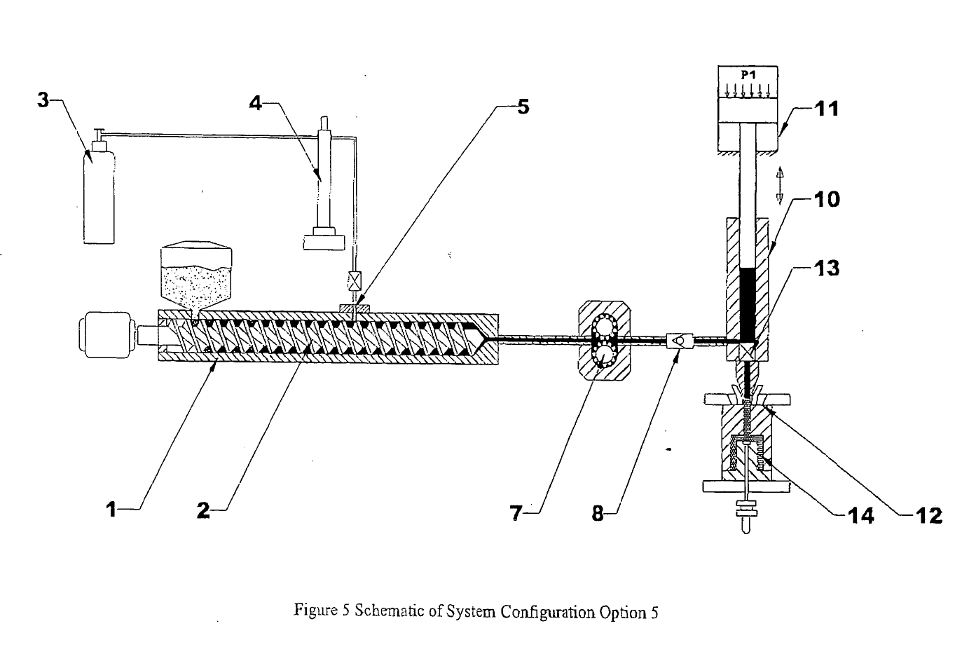

FIG. 5 shows another variation, of Option 1. The differences are that no secondary accumulator is added and a non-returnable check valve (8) is used between the main accumulator (10) and the gear pump (7) instead of a shut-off valve. Since the non-returnable check valve (8) allows the melt flow only in one direction, i.e., from the gear pump (7) to the main accumulator (10), but not in the opposite direction, a continuous screw rotation with a constant barrel pressure can be realized. This will simplify the modification to the existing system. However, because of the possibility of the high pressure surge in the down stream of the gear pump (7), the gear pump (7) may be broken down easily. A lower injection pressure in the accumulator (10) may have to be used. Furthermore, the shot-size control will be more difficult.

### Option 6:

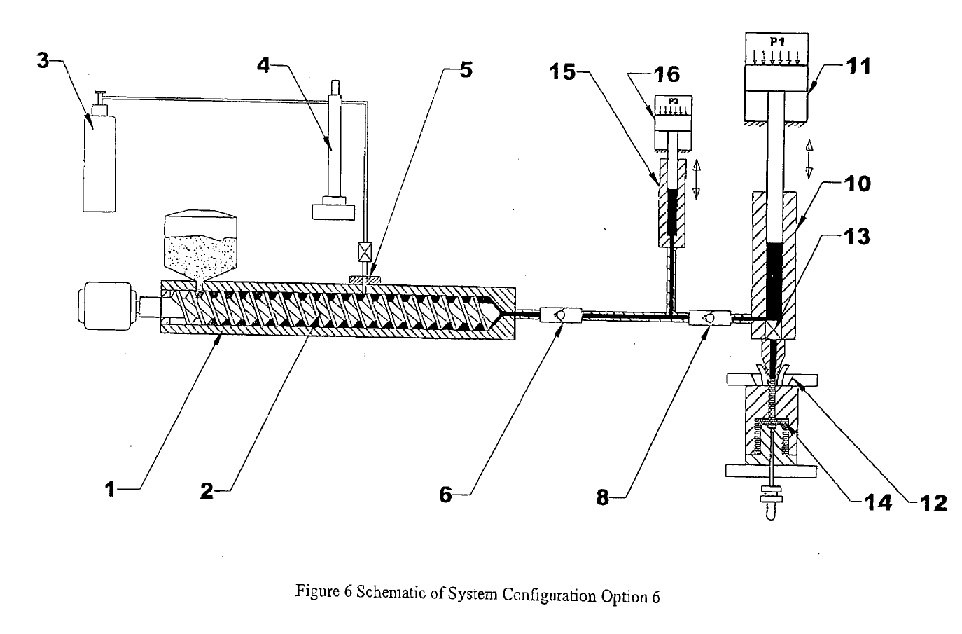

FIG. 6 shows a variation of Option 3. The difference is that a non-returnable check valvet (8) is used between the secondary accumulator (15) and the main accumulator (10) instead of a shut-off valve. Due to the one-way flow feature of the non-returnable check valve (8), it will be relatively easier to realize a continuous screw rotation without strict timing control of valve operations during injection and molding operations.

### Option 7:

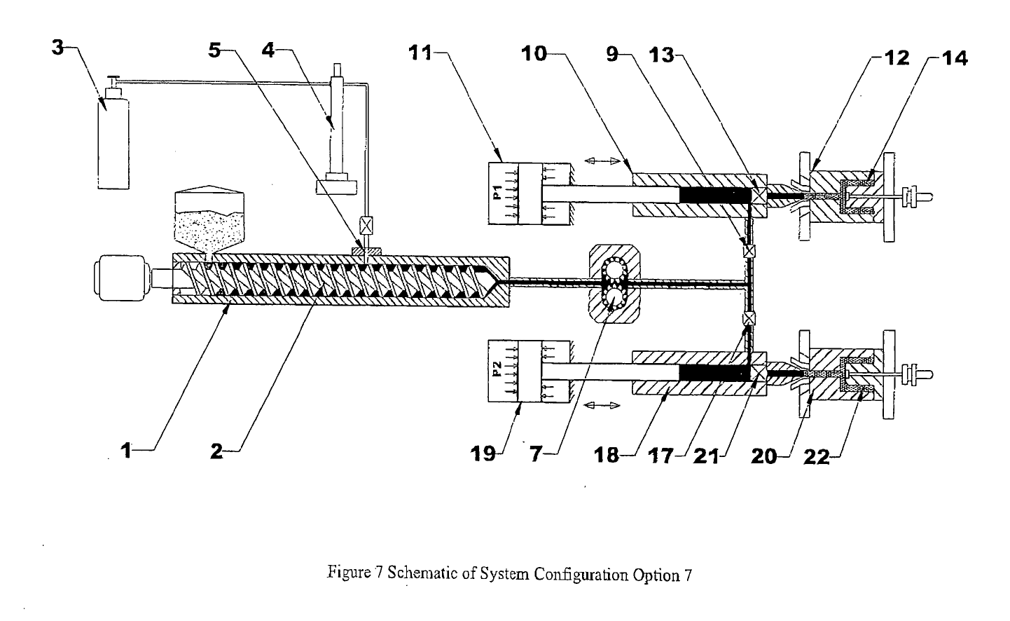

FIG. 7 shows another system configuration. Instead of utilizing two different accumulators after the gear pump, as shown in the other options, two compatible accumulators (10 and 18) and molding units (12 and 20) are attached after the gear pump (7) so that each accumulator-molding unit can be alternating. When the first accumulator (10) is receiving the material from the gear pump (7) through the opened shut-off valve (9), the other shut-off valve (17) attached to the other accumulator (18) is closed. Once the required amount of material is stored in the accumulator (10), the shut-off valve (9) is closed and at the same time, the other shut-off valve (17) is opened to accumulate the flowing polymer/gas mixture to the other accumulator (18). During this accumulation process in the other accumulator, injection (or mold filling) is performed in the first molding system. Namely, the first nozzle shut-off valve (13) is opened and the foamable polymer/gas mixture stored in accumulator (10) is injected into the mold (12) under high pressure in the hydraulic system (11). When mold filling is done, the nozzle shut-off valve (13) is closed and the accumulator (10) is ready to receive the polymer/gas mixture. When the molded part (14) is cooled, it is ejected out. On the other hand, when the accumulation is done in the other accumulator (18), the other shut-off valve (17) is closed and the first shut-off valve (9) is opened simultaneously. At the same time, the other nozzle shut-off valve (21) is opened and the injection and molding operations are conducted in the other molding system. This alternating accumulation and injection will be continued. The amount of polymer/gas mixture can be controlled by the rotational, speed based on the shot sizes of these two molding systems and the required cooling times. In another alternative to this option, more than two accumulators and molding units can be used.

### Option 8:

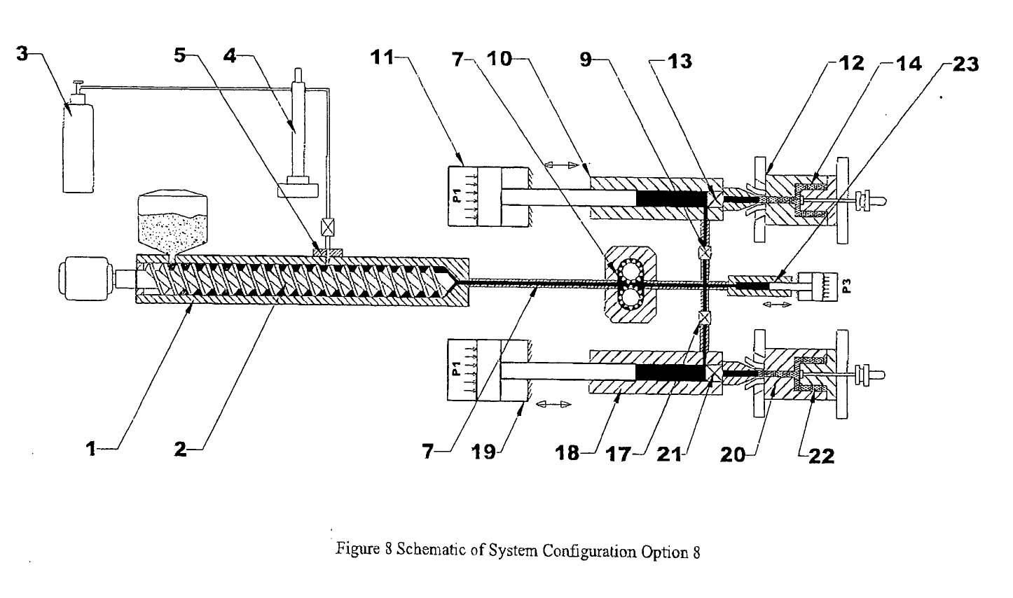

FIG. 8 shows another variation of Option 7. The difference is that a bypass accumulator will be additionally used for the multi-molding system. A gear pump and a bypass accumulator are used to facilitate the achievement of a continuous rotation of plasticating screw and a consistent, gas dosing.

### Option 9:

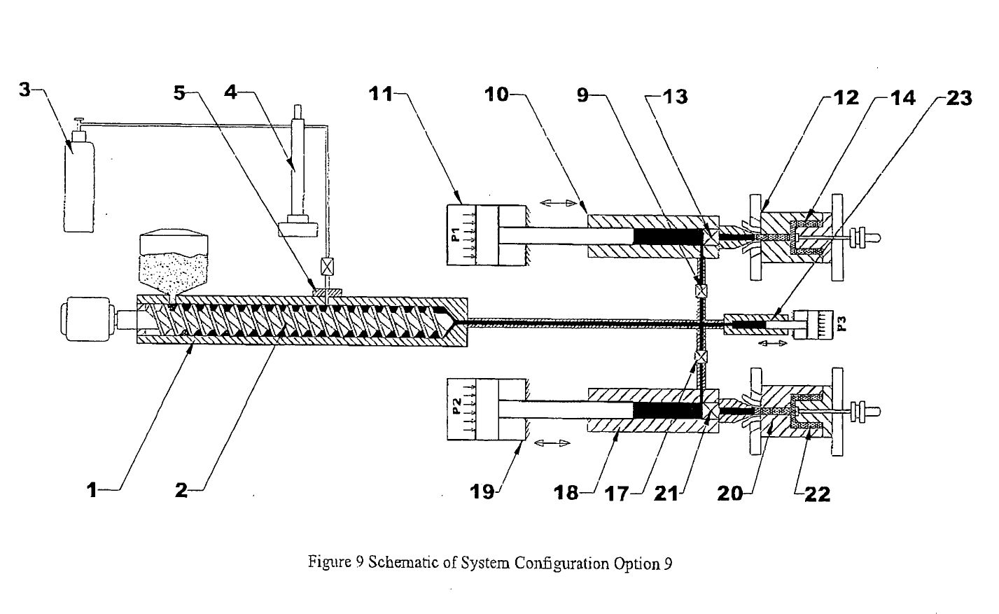

FIG. 9 shows another variation of Option 7. The difference is no gear pump is added between the extrusion barrel (1) and the main accumulators (10 and 18). instead, an accumulator is attached. In this case a continuous rotation of plasticating screw and a consistent gas dosing can be still realized through close control of the shut-off valves (9 and 17). The modification for retrofitting to the existing system is simplified using this option. Option 10:

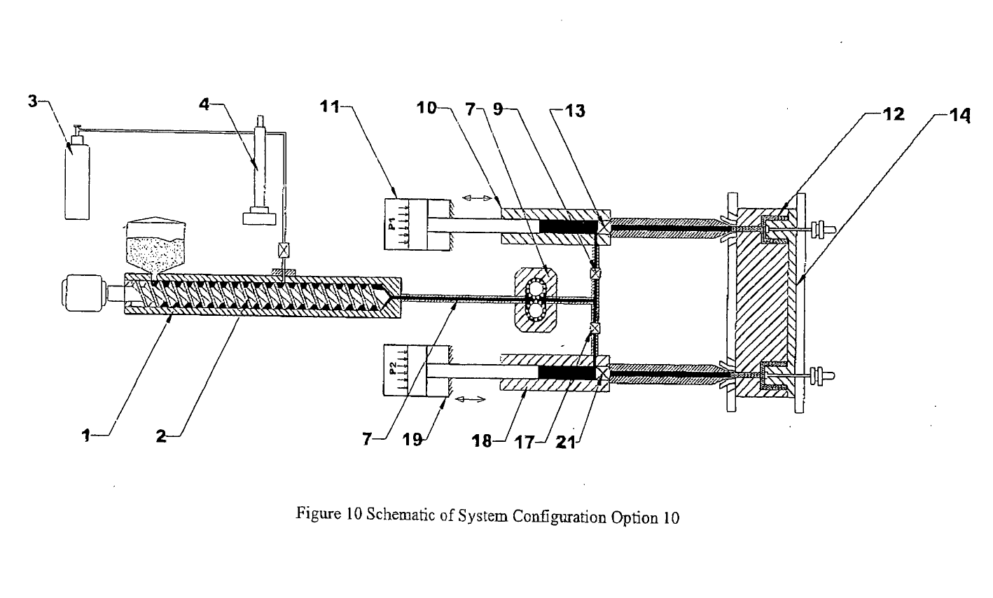

FIG. 10 shows a variation of Option 1 for a multi-accumulator and single-mold system that has a single large cavity or multiple cavities in the mold. For a multi-cavity mold, both the accumulators (10 and 18) and the mold cavities can be filled in sequence, and continuous rotation of the plasticating screw and consistent gas dosing can be easily achieved. For a large cavity mold injection may need to be done by multi accumulators in sequence. With the gear pump (7), the pressure in the barrel (1) will be maintained easily.

### Option 11:

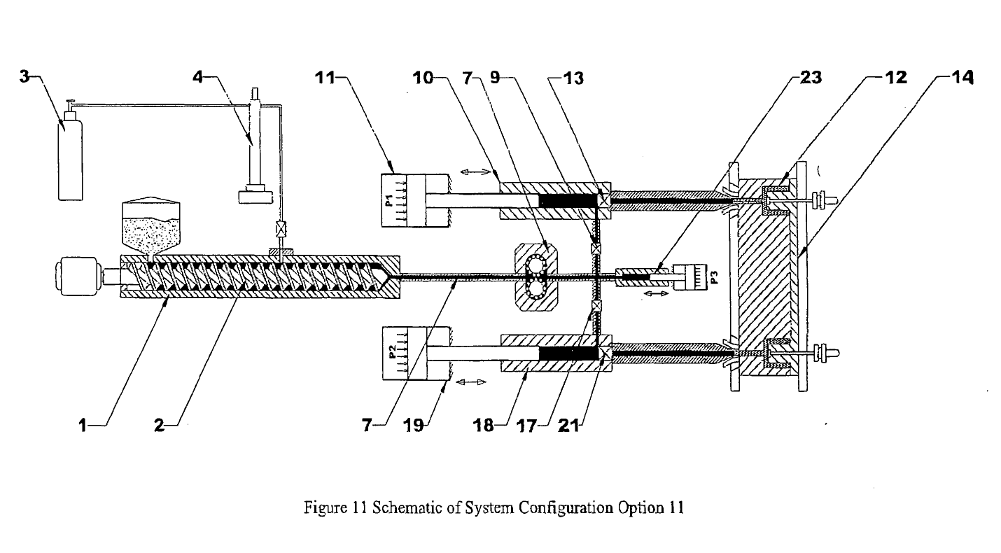

FIG. 11 shows a variation of Option 10 for a multi-accumulator and single-mold system that has a single large cavity or multiple cavities in the mold. The difference is that a bypass accumulator will be additionally used for the multi-molding system. A gear pump and a bypass accumulator are used to facilitate the achievement of a continuous rotation of plasticating screw and a consistent gas dosing. For a large cavity mold, injection can be done by multi accumulators simultaneously or in sequence. Even in the case of simultaneous injection, the accumulators can be filled in sequence, and the secondary accumulator (hydraulic piston, spring-loaded piston, or expandable tube) (23) is helpful to accommodate the melt during injection so that a continuous rotation of extruder screw and a consistent gas dosing can be realized.

### Option 12:

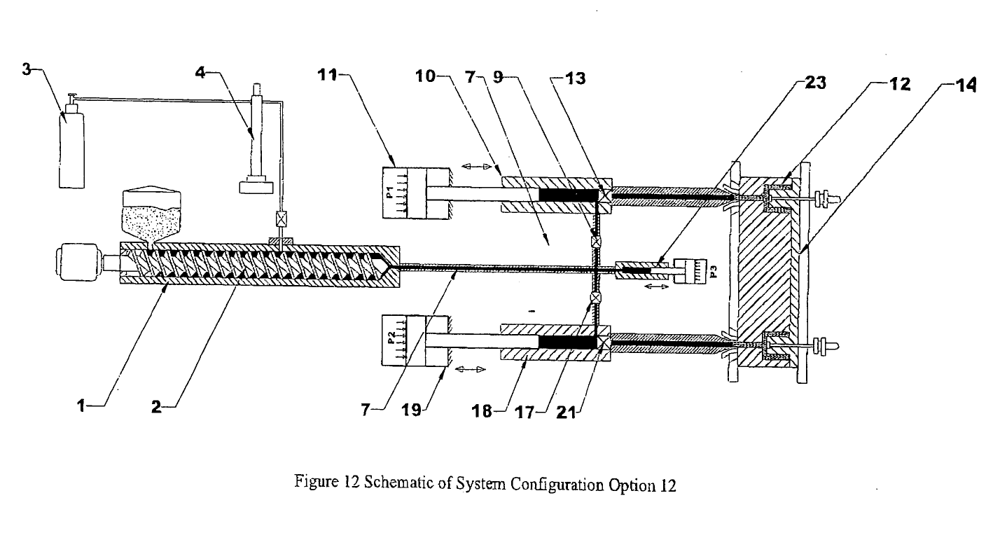

FIG. 12 shows a variation of Option 10. The difference is that no gear pump is added between the extrusion barrel (1) and the accumulators (10 and 18). Instead, an accumulator is attached. In this case, a continuous rotation of plasticating screw and a consistent gas dosing can be still realized through close control of the shut-off valves (9 and 17). The modification for retrofitting to the existing system is simplified using this option.

In all of the options described, where no specific mention is made of the possible substitution of one apparatus for another (i.e., a check valve for a gear pump, a spring loaded piston for a hydraulic piston, or multiple accumulators and molding units for a single accumulator and molding unit), those substitutions are all encompassed by the present invention and disclosure.

### EXAMPLES

A series of critical experiments were conducted to verify the validity of the technology based on the present invention. HDPE (H5534, Equistar Chemical) was selected as the plastic material because HDPE is most widely used in structural foam molding. Talc and N₂ were used as the nucleating agent and blowing agent, respectively, in the critical experiments. A total of 21 sets of experiments were conducted while varying the talc size, talc content, and N₂ content as shown in Table 1. To investigate the effect of the talc size, two kinds of talc (0.8 microns and 2.5 microns) were used. The talc content was varied from 0.1% to 1.0% whereas the N₂ content was varied from 0.1% to 0.5% (at relatively low levels in consideration of the low solubility of N₂).

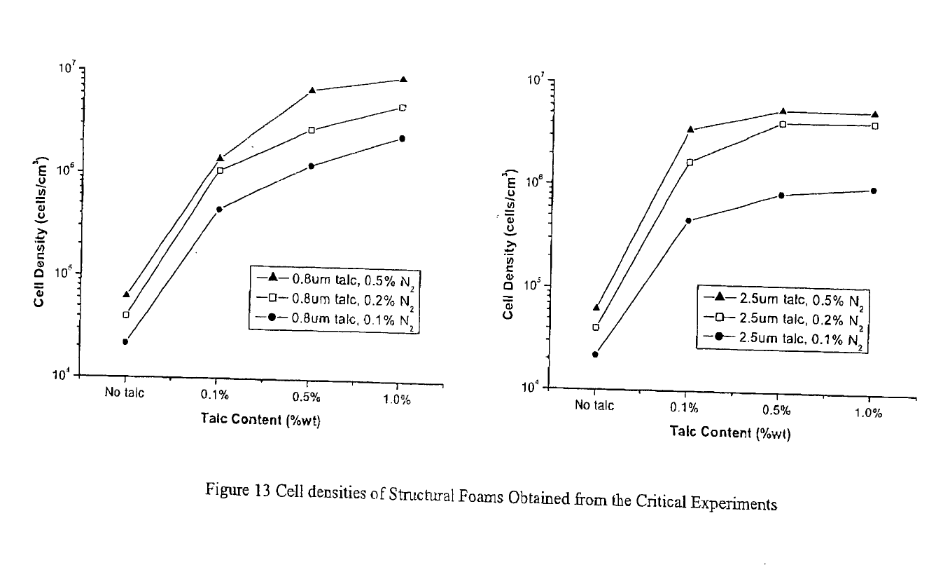

The results of the critical experiments were very positive as shown in FIG. 13. For all the combinations of the talc size, talc content, and N₂ content, very uniformly distributed fine-celled structures were successfully obtained throughout the volume of the structural foams. Even for the cases of using no talc, the cellular structures were very uniform although the cell densities were relatively low in the range of 10⁴ about.10⁵ cells/cm³ But when talc was added, the cell density was dramatically increased in the range of 10⁵ about.10⁷ cells/cm³ and the cell structure was more uniform. Especially, when the N₂ content was higher than 0.2%, the cell density became greater than 10⁶ cells/cm³ even with 0.1% talc content. This demonstrates that the cell morphology of structural foams will be improved significantly when the heterogeneous cell nucleation mechanism is appropriately used by distributing the talc particles properly and by dissolving the gas uniformly in the melt using the present invention. It is obvious that the heterogeneous nucleation mechanism has not worked properly in the existing structural foam molding systems even with the added talc particles, because the injected N₂ gas did not uniformly dissolve in the polymer melt.

It was observed that as the talc content increased, the cell density increased, but at some point, the cell density did not increase further with the talc content. As the talc size was changed, the cell nucleation behavior was entirely changed. Although the total number of talc particles became increased by an order of magnitude when the talc size was decreased from 2.5 microns to 0.8 microns, the cell density was not increased proportionally to the number of talc particles. Because of the smaller surface area and potentially more segregating tendency of the smaller (0.8 microns) particles, the cell nucleating behaviors of the two talc particles were very different as the N₂ content was varied. But overall, as the blowing-agent content was increased, the cell density was increased for both cases. The results demonstrate that the talc size, the talc content, and the blowing-agent (N₂) content affect significantly the cell density of the structural HDPE foams produced based on this invention.

All these cell-nucleation results of injection-molded structural foams were very comparable to those of the extrusion foams obtained in our laboratory using the same plastic, the same nucleating agent, and the same blowing agent with low pressure-drop rate dies. This strongly indicates that the cell nucleation mechanisms of the present invention are exactly the same as those of conventional extrusion foaming as described above.

The void fraction was varied by controlling the shot size of the polymer/gas mixture in the main accumulator for the fixed volume of mold cavity. For each set of experiment with fixed, talc and N₂ contents, various void fractions in the range of 10%.about.60% were successfully achieved without formation of any large gas pockets or a non-uniform cell structure unlike the existing structural foams. Although the cell size was greater with an increase in the void fraction by using a reduced shot size, a very uniform cellular structure was achieved. This indicates that a very high void fraction up to 60% can be obtained from this technology without forming any large gas pockets or a non-uniform cell structure. Therefore, even for a high void fraction, the rate of scrapping/recycling the defective structural-foam products due to the formation of large gas pockets will be completely removed using the present technology.

All the cellular morphologies were consistently observed with respect to time, and there were no changes in the results for several hours. This means that the injected N₂ was dispersed well in the polymer (HDPE) melt, and thereby the commonly observed non-steady behaviors of the product quality and processing conditions due to the undissolved N₂ from the existing structural foams dissappeared completely using this technology.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. A structural foam molding method comprising:
advancing a polymer/gas-containing melt flow stream through an extruder by the rotation of at least one rotating screw disposed therein;
passing said advancing polymer/gas-containing melt flow stream to an accumulator through a first shut-off valve, said accumulator in communication with a mold through a second shut-off valve;
filling said accumulator with a quantity of said advancing polymer/gas-containing melt flow stream;
closing said first shut off valve and opening said second shut-off valve;
filling said mold by transferring said quantity of said advancing polymer/gas-containing melt flow stream from said accumulator to said mold; and
allowing the continued rotating of said at least one screw and advancing of said polymer/gas-containing melt flow stream while said first valve is closed during said mold filling.

36. A structural foam molding method comprising:
advancing a polymer/gas-containing melt flow stream through art extruder by the rotation of at least one rotating screw disposed therein;
passing said advancing polymer/gas-containing melt flow stream to an accumulator through a check valve, said accumulator in communication with a mold through a shut-off valve;
filling said accumulator with a quantity of said advancing polymer/gas-containing melt flow stream;
opening said shut-off valve;
filling said mold by transferring said quantity of said advancing polymer/gas-containing melt flow stream from said accumulator to said mold; and
allowing the continued rotating of said at least one screw and advancing of said polymer/gas-containing melt flow stream during said mold filling.

37. A structural foam molding method comprising:
advancing a polymer/gas-containing melt flow stream through an extruder by the rotation of at least one rotating screw disposed therein;
passing said advancing polymer/gas-containing melt flow stream to a plurality of accumulators through a first shut-off valve associated with each accumulator, each of said accumulators in communication with a mold through a second shut-off valve;
filling said accumulators with a quantity of said advancing polymer/gas-containing melt flow stream by opening said first shut-off valve;
filling said molds by transferring said quantity of said advancing polymer/gas-containing melt flow stream from said accumulators to said molds by closing said first shut off valve and opening said second shut-off valve; and
allowing the continued rotating of said at least one screw and advancing of said polymer/gas-containing melt flow stream during mold filling by managing the sequencing of opening and closing said first shut-off valves so that the first shut-off valve associated with at least one of the plurality of accumulators is open when the first shut-off valve associated with at least one other of the plurality of accumulators is closed.

38. A structural foam molding method comprising:
advancing a polymer/gas-containing melt flow stream through an extruder by the rotation of at least one rotating screw disposed therein;
passing said advancing polymer/gas-containing melt flow stream to a plurality of accumulators, each of said accumulators in communication with a mold through a shut-off valve;
filling said accumulators with a quantity of said advancing polymer/gas-containing melt flow stream;
filling said molds by transferring said quantity of said advancing polymer/gas-containing melt flow stream from said accumulators to said molds by opening said shut-off valve; and
allowing the continued rotating of said at least one screw and advancing of said polymer/gas-containing melt flow stream during mold fining by managing the sequencing of opening and closing said shut-off valves so that the shut-off valve associated with at least one of the plurality of molds is open when the shut-off valve associated with at least one other of the plurality of molds is closed.

39. A structural foam molding method comprising:
advancing a polymer/gas-containing melt flow stream through an extruder by the rotation of at least one rotating screw disposed therein;
passing said advancing polymer/gas-containing melt flow stream to a plurality of accumulators through a check valve associated with each accumulator, each of said accumulators in communication with a mold through a shut-off valve;
filling said accumulators with a quantity of said advancing polymer/gas-containing melt flow stream through said check valve;
filling said molds by transferring said quantity of said advancing polymer/gas-containing melt flow stream from said accumulators to said molds by opening said shut-off valve; and
allowing the continued rotating of said at least one screw and advancing of said polymer/gas-containing melt flow stream during mold

40. A structural foam molding method according to claim 39, further comprising:
managing the sequencing of opening and closing said shut-off valves so that the shut-off valve associated with at least one of the plurality of molds is open when the shut-off valve associated with at least one of the plurality of molds is closed.

41. In a structural foam molding process, which process comprises:
advancing a polymer/gas-containing melt flow stream through an extruder by the rotation of at least one rotating screw disposed therein; passing said advancing polymer/gas-containing melt flow stream to at least one accumulator associated with a mold; filling said at least one accumulator with a quantity of said advancing polymer/gas-containing melt flow stream; filling said molds by transferring said quantity of said advancing polymer/gas-containing melt flow stream from said accumulators to said molds; the improvement comprising:
allowing continued, rotating of said at least one screw and advancing of said polymer/gas-containing melt flow stream during mold filling through the use of at least one positive displacement pump disposed between said extruder and said at least one accumulator.

42. In a structural foam molding process, which process comprises:
advancing a polymer/gas-containing melt flow stream through an extruder by the rotation of at least one rotating screw disposed therein; passing said advancing polymer/gas-containing melt flow stream to at least one accumulator associated with a mold; filling said at least one accumulator with a quantity of said advancing polymer/gas-containing melt flow stream; filling said molds by transferring said quantity of said advancing polymer/gas-containing melt flow stream from said accumulators to said molds; the improvement comprising:
allowing continued rotating of said at least one screw and advancing of said polymer/gas-containing melt flow stream during mold filling through the use of at least one accumulator not in communication with a mold.

43. In a process for producing structural molded foams, which process comprises extruding, injecting and molding a polymer/gas-containing melt flow stream, wherein said extruding comprises advancing said stream by at least one or more rotating screws, and wherein said rotating of said one or more screws is stopped during said injecting and molding, the improvement comprising:
continuing said rotating of said one or more screws and said advancing of said polymer/gas-containing melt flow stream during said injecting and molding.

44. A structural molded foam comprised of polymer-containing matrix, a cell density in the range of 10,000 cells/cm³ to 10,000,000 cells/cm³, and containing any or no nucleating agent.
